(19) United States
(12) Patent Application Publication
(10) Pub. No.: US 2024/0346967 A1
(43) Pub. Date: Oct. 17, 2024

(54) Automated Device-Interaction Emulator for Provisioning and Testing

(71) Applicant: Esper.io, Inc., Bellevue, WA (US)

(72) Inventor: Nikhil Punathil Ellath, Bellevue, WA (US)

(21) Appl. No.: 18/634,537

(22) Filed: Apr. 12, 2024

Related U.S. Application Data
(60) Provisional application No. 63/458,994, filed on Apr. 13, 2023.

(51) Int. Cl. G09G 3/00; G06V 20/52

(52) U.S. Cl. CPC G09G 3/006; G06V 20/52

(57) ABSTRACT

Systems and methods for automated device-interaction emulation for provisioning and testing of devices are disclosed. In some embodiments, a system includes a processor, and a memory, the memory storing processor-readable instructions configured to perform operations including: monitoring a display of a device using an imaging system; providing one or more input signals to the device to simulate one or more human inputs; analyzing information recorded by the imaging system to determine a state of the device responsive to the one or more input signals; and determining whether the state of the device is indicative of a successful operating condition based at least partially on the information recorded by the imaging system. The operations may include adjusting one or more input signals to the device, and re-analyzing information recorded by the imaging system to determine a new state of the device responsive to the adjusted one or more input signals.

### CROSS REFERENCE TO RELATED APPLICATIONS

This patent application claims priority benefits under 35 USC § 119 (e) from the following U.S. provisional patent application: U.S. Provisional Patent Application No. 63/458,994 filed on Apr. 13, 2023, which application is incorporated herein by reference.

### FIELD OF THE DISCLOSURE

The present disclosure relates generally to device management, and more specifically, to device provisioning and testing.

### BACKGROUND

Many contemporary business enterprises employ mobile computing devices for a wide variety of purposes, including product sales, inventory management, communications, tracking, record keeping, and other suitable purposes. Management of such devices typically requires installation of various software components that may depend on various aspects of the device that is being provisioned, and which typically requires participation of a user of the device to make suitable selections via a user interface (UI) for installation and testing of the software components. Although desirable results have been achieved using prior art systems and methods, there is room for improvement.

### SUMMARY

Systems and methods for automated device-interaction emulation for provisioning and testing are disclosed herein. Embodiments of systems and methods for automated device-interaction emulation for provisioning and testing as disclosed herein may advantageously provide improved efficiency and operational results in the provisioning and testing of managed devices.

For example, in some embodiments, a system includes a processor, and a memory, the memory storing processor-readable instructions configured to perform operations including: monitoring a display of a device using an imaging system; providing one or more input signals to the device to simulate one or more human inputs; analyzing information recorded by the imaging system to determine a state of the device responsive to the one or more input signals; and determining whether the state of the device is indicative of a successful operating condition based at least partially on the information recorded by the imaging system. The operations may include adjusting one or more input signals to the device, and re-analyzing information recorded by the imaging system to determine a new state of the device responsive to the adjusted one or more input signals.

In some embodiments, the input signals may be provided to the device from a signal device to simulate one or more human via a human interface device (HID). In further embodiments, the input signals may be provided to the device from a single board computer (SBC) to simulate one or more inputs via a USB HID.

In some embodiments, the analyzing of the information recorded by the imaging system includes analyzing information recorded by the imaging system using one or more computer vision techniques (e.g. optical character recognition (OCR), template matching, etc.).

In some embodiments, the determining whether the state of the device is indicative of a successful operating condition includes determining whether a successful software installation has been achieved, or determining whether a successful software testing condition has been achieved.

There has thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting.

### BRIEF DESCRIPTION OF THE DRAWINGS

Embodiments of methods and systems in accordance with the teachings of the present disclosure are described in detail below with reference to the following drawings.

FIG. 1 shows an embodiment of a representative environment for implementing techniques and technologies in accordance with the present disclosure.

FIG. 2 shows an embodiment of a process in accordance with the present disclosure.

FIG. 3 is a schematic view of an exemplary computing device configured to operate in accordance with the present disclosure.

### DETAILED DESCRIPTION

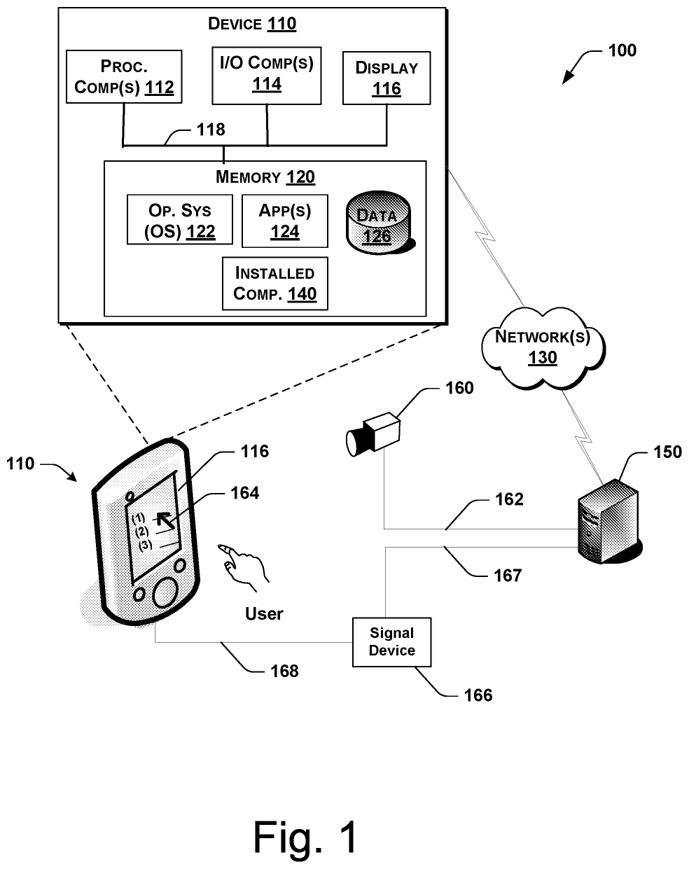

Systems and methods for automated device-interaction emulation for provisioning and testing are described in the following disclosure. Many specific details of certain embodiments are set forth in the following description and in FIGS. 1-3 to provide a thorough understanding of such embodiments. One skilled in the art will understand, however, that the invention may have additional embodiments, or that alternate embodiments may be practiced without several of the details described in the following description.

Embodiments of systems and methods for automated device-interaction emulation for provisioning and testing as disclosed herein may advantageously provide improved efficiency and operational results in the provisioning and testing of managed devices. More specifically, embodiments in accordance with the present disclosure may allow automation of provisioning processes, as well as testing of new versions of installed components as they are provisioned on real devices in an automated manner, whereas currently this process is manually performed by a human.

For example, in some embodiments, systems and methods as disclosed herein may automate the setup and provisioning of a mobile device, such as an Android device, through user interface (UI) automation. In some embodiments, such automation may be accomplished by emulating a human interface device (HID), such as mouse, using the USB-C bidirectional port on a Raspberry Pi 4. A camera may be mounted such that it has a clear view of the device being tested is used as a source of images that is processed by a computer vision algorithm in order to identify the coordinates of the location that the “mouse” should move to and/or click. This way, an entire automation routine can be scripted by simply writing a list of text fields that need to be clicked on the device. Additionally, in some embodiments, a system can also fallback to using Android Debug Bridge (ADB) for automation, once the initial device setup is complete, to allow for a more traditional format of Android UI automation.

In at least some embodiments, systems and methods as disclosed herein may employ one or more of the following operational aspects: (1) emulation of a human interface device (HID) using a Raspberry Pi 4 over USB C, (2) processing the frames from a mounted camera and forwarding them to a CV algorithm for text detection, (3) mapping detected text to approximate locations on the screen, (4) tracking approximate locations on the screen offline to look for a delta in the image frames, thus detecting when the mouse cursor has passed over the location, (5) parsing of custom automation scripts including delays and custom taps/dragging UI elements, and/or (6) automatic optional switching to ADB based UI test suite of choice when initial setup complete and ADB is enabled.

FIG. 1 is an embodiment of a representative environment 100 for implementing techniques and technologies in accordance with the present disclosure. In this embodiment, the environment includes a device 110 operatively coupled by one or more networks 130 to a provisioning system 150. The one or more networks 130 may include wireless (or wired) networks, and may enable the provisioning system 150 to communicate with the device 110 from any desired location.

In this embodiment, the device 110 includes one or more processing components 112, one or more input/output (I/O) components 114, and a display 116, all of which are operatively coupled to a memory 120 via a bus 118. As further shown in FIG. 1, the memory 120 may store an operating system (OS) 122, one or more applications 124, data 126, or any other suitable information or facilities. In at least some embodiments, the operating system 122 may be an Android operating system developed by the Open Handset Alliance and commercially sponsored by Google, Inc. (e.g. AOSP, Android 9, Android 13, etc.). The device 110 may receive inputs from a user via one or more of the I/O components 114 of the device 110 (e.g. touch screen, keypad, microphone, mouse, keyboard, electronic pen, etc.). In addition, the device 110 may receive inputs from other devices via one or more of the I/O components 114 (e.g. USB ports, antennas, transceivers, etc.) as described more fully below.

In the embodiment shown in FIG. 1, the memory 120 of the device 110 also stores an installed component 140 that may be provisioned onto the device 110 by the provisioning system 150. For example, in some embodiments, the installed component 140 may be a Mobile Device Management (MDM) agent which handles the logic for managing the device according to the needs of a business enterprise. The installed component 140 may perform a variety of operations on the device 110, and may receive inputs, such as for installation and testing of the installed component 140, via the one or more of the I/O components 114 of the device 110.

It will be appreciated that the device 110 shown in FIG. 1 is merely one particular embodiment that may be used in accordance with the present disclosure. For example, although the device 110 in FIG. 1 is depicted as a hand-held or mobile device (e.g. cell phone, tablet, personal data assistant, etc.), it will be appreciated that in alternate embodiments, a wide variety of alternate embodiments of devices may be suitable employed, including, laptop computers, desktop computers, or any other suitable devices. Also, in alternate embodiments, the device 110 may have a plurality of installed components 140.

As further shown in FIG. 1, the environment 100 may further include an imaging device 160 (e.g. video camera) that is operatively coupled to the provisioning system 150 via a first communication link 162. The imaging device 160 may be directed at the display 116 of the device 110, and may be configured to record information that is displayed on the display 116 and communicate that information to the provisioning system 150 via the first communication link 162. For example, in some embodiments, the imaging device 160 may detect a position of a symbol 164 (e.g. cursor) that is displayed on the display 116 of the device 110, and return information indicating the position of the symbol 164 to the provisioning system 150.

In addition, in some embodiments, the environment 100 may include a signal device 166 operatively coupled to the provisioning system 150 by a second communication link 167, and also to the device 110 by a third communication link 168. In at least some embodiments, the signal device 166 is configured to provide inputs to the device 110 that resemble those provided by a human interface device (HID). It will be appreciated that the various communication links 162, 167, 168 shown in FIG. 1 may be wired or wireless communication links.

In at least some embodiments, systems and methods in accordance with the present disclosure may be used to perform end to end software testing on real devices using simulated input and computer vision. In some environments, certain kinds of software cannot rely on existing UI test frameworks powered by a device's operating system APIs. For example, the provisioning of device management software (e.g. installed component 140) on Android devices typically may happen at a stage prior to the device being ready for traditional UI testing through the Android Debug Bridge (ADB). In these situations, it may be desirable to provide a testing platform that is as close to real human interaction as possible (e.g. using a low level medium that is always active) even before the device is set up. In some embodiments, this may be accomplished by simulating dynamic inputs (e.g. mouse clicks) using the signal device 166 connected to the device 110 (e.g. via USB), which receives visual feedback from a camera feed (e.g. from the imaging device 160) that may be processed through computer vision techniques (e.g. by the provisioning system 150), such as optical character recognition (OCR) and template matching. In some embodiments, systems and methods in accordance with the present disclosure can be further integrated with traditional testing platforms to offer an end to end testing experience, simulating a testing experience that includes human interaction.

In at least some embodiments, such as device management testing or OS platform testing, it may be desirable to validate an entire flow of a user's experience, right from a device being unboxed and set up for the first time. Device management applications may be installed onto a device soon after a device is first turned on, and in at least some instances, before Android allows the Android Debug Bridge (ADB) to be enabled by the user. This onboarding process, typically referred to as provisioning, may be an important part of a device management platform's lifecycle, and may often be affected by issues specific to certain models of devices, or certain versions of Android. Accordingly, it may be desirable to provide a testing platform (e.g. environment 100) for end to end software testing that does not rely on developer tools such as ADB.

With continued reference to FIG. 1, the environment 100 generally includes the provisioning system 150, the imaging device 160, and the signal device 166. In some embodiments, the signal device 166 may comprise a single board computer (SBC) operatively coupled to the device 110 by the third communication link 168 (e.g. via a USB cable). The imaging device 160 is connected to the provisioning system 150. In at least some embodiments, the provisioning system 150 is a primary computer running the core software application. The imaging device 160 may provide a video feed that the software on the provisioning system 150 processes to determine the states of the device 110, or other devices under test (DUTs). In some embodiments, the software operating on the provisioning system 150 may be designed to be able to process the state of multiple devices at a time, using a physical identifier (such as a QR code) to uniquely recognize different devices. This information may be used by the provisioning system 150 to send appropriate instructions to the signal device 166 coupled to the device 110, or to a plurality of individual signal devices (or SBCs) connected to multiple DUTs.

In at least some embodiments, the signal device 166 is designed to be recognized as a USB Human Input Device (HID) by the device 110, and therefore is also responsible to convert the commands received from the provisioning system 150 into low level HID report descriptors, which is akin to a human using an HID to perform actions on the device 110. In some embodiments, a user who wishes to test the device 110 may write various test routines, which includes different actions that need to be performed through input simulations, based on well-defined states of the device 110. For example, the states may be defined by the user through either text that is expected on the display 116 of the device 110, or templates of how the display 116 or a UI element on the display 116 is supposed to look.

In some particular embodiments, input may be simulated using the signal device 166 that may comprise a Single Board Computer, such as a Raspberry Pi, capable of running as a USB device. This may be accomplished, for example, using a USB port (e.g. USB 3.0 or older port) with USB On-the-Go (OTG) support, or alternately, by using a newer USB 3.1+ port capable of the USB Dual Role standard.

In some embodiments, the signal device 166 includes a software controllable USB mode. In addition, in at least some embodiments, a signal application operating on the signal device 166 (e.g. an SBC application) may be written in a suitable coding language (e.g. Python) that is not dependent on a particular architecture. The role of the signal application may include switching the signal device 166 between host and device mode, and converting high level instructions (e.g. received in the form of X and Y coordinates as well as click information, etc.) from the provisioning system 150 to low level signals (e.g. mouse HID report descriptors, etc.) that the device 110 (or DUT) recognizes.

Once the device 110 moves past initial setup and ADB is enabled, further test cases that run over ADB can be sent to the signal device 166 from the provisioning system 150 for testing the device 110 using the ADB. In some embodiments, in order for ADB to recognize the device 110 without replugging the USB cable (third communication link 168), it may be desirable to switch a host port on the signal device 166 to Host mode once again in order to allow the device 110 to be detected as an ADB device. Once ADB over USB is enabled, the signal device 166 (or SBC) can also turn on ADB over IP, thus enabling the provisioning system 150 to access and run tests on the device 110 directly, without a middleman in the form of the signal device 166.

In some embodiments, the imaging device 160 may be used to monitor the display 116 of the device 110 to determine information used in the provisioning or testing of the device 110, such as, for example, determining state of the device 110, click locations, and other desired information. In some embodiments, the imaging device 160 includes a high quality camera for monitoring the device 110 (or to monitor multiple DUTs) to determine the state of the device 110. The states of the device 110 may be defined by the user in the form of one or more scripts. In some embodiments, for example, states may be defined by specifying text to expect on the display 116 of the device 110, or in the case of a display 116 without any text, a template screenshot of what to expect. In some embodiments, the script may define the locations of taps using the defined states in a sequential manner. For example, in a particular embodiment, a routine (or script) may include the following operations: (1) Click Start, (2) Wait for Wi-Fi, (3) Click 108, 950, (4) Wait for “email address”, (5) Click 150, 560, (6) Input text afw #esper, and (7) Wait for “Provisioning Complete.”

The click locations (in (3) and (5) above) may be XY coordinates or specific text located on the UI element that needs to be clicked. In the case text is specified, in some embodiments, as soon as the required state is reached, the frame from the imaging device 160 may be processed by an OCR algorithm on the provisioning device 150 to determine the location of the click point. However, since the XY coordinates may be relative to the camera feed and not the actual device 110 itself, the application operating on the provisioning system 150 may estimate the real XY location while closely tracking the camera XY area of the text for a change in image produced by the cursor 164 moving over. This information may be used to calculate a delta between real XY and camera XY coordinates for more accurate and faster clicks. In some embodiments, this information may also be stored on a device model level internally (e.g. by provisioning system 150), so that future test runs on the same device 110 can be accelerated.

In some embodiments, the imaging device 160 is configured to track the state of multiple DUTs at the same time, and may even be configured to do so from within the same frame. For example, in some embodiments, a state tracking application (e.g. operating on the provisioning system 150 or on the imaging device 160) may be designed to isolate just the displays from a video feed of the imaging device 160, and different devices may be identified by suitable means, such as by QR codes placed near them.

As noted above, in some embodiments, embodiments of systems and methods in accordance with the present disclosure may be integrated with existing testing platforms for unified end to end testing. For example, in some embodiments, repeated end to end testing of devices may be accomplished using a combination of ADB-based testing frameworks along with the aforementioned components of the environment 100. Once the DUT (e.g. device 110) reaches a stage where ADB can be enabled through simulated inputs, ADB over IP can also be turned on with a single command and the device 110 can integrate seamlessly with other devices being tested by another UI testing framework. Once the traditional test cases are completed, the loop may be started all over again and the process can be repeated infinitely. Embodiments in accordance with the present disclosure may be particularly useful for testing device setup or for device management provisioning, where multiple methods may be used and the details can vary based on manufacturer and OS version.

It may be appreciated, however, that certain kinds of software may not rely on existing user interface (UI) test frameworks powered by a device's operating system APIs. For example, the provisioning of device management software (e.g. MDM agents, etc.) on Android devices typically needs to happen at a stage prior to the device being ready for traditional UI testing through the Android Debug Bridge (ADB). In these situations, there is a need for a testing platform that is as close to real human interaction as possible, using a low level medium that is always active, even before the device is set up. Embodiments of systems and methods in accordance with the present disclosure enable this to be performed successfully by simulating dynamic mouse clicks using a computer connected via USB, which receives visual feedback from a camera feed that's processed through suitable computer vision techniques, such as optical character recognition (OCR) and template matching. Accordingly, embodiments of systems and methods in accordance with the present disclosure may be further integrated with traditional testing platforms to advantageously offer an end to end testing experience, as close to a real human as possible

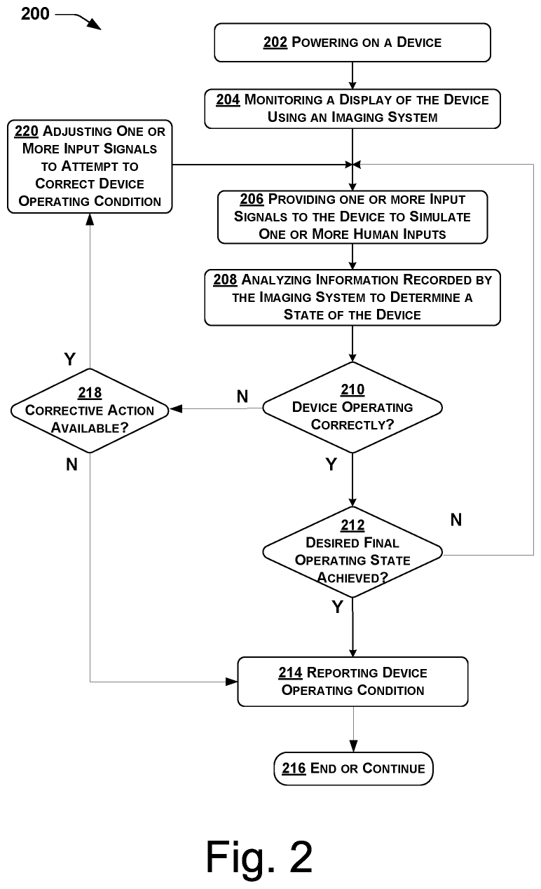

FIG. 2 is an embodiment of a process 200 in accordance with the present disclosure. In this embodiment, the process 200 includes powering on a device at 202, and monitoring a display of the device using an imaging system at 204. The process 200 further includes providing one or more input signals to the device from a signal device to simulate one or more human inputs at 206. For example, in some embodiments, the providing one or more signals (at 206) is performed by a signal device 166 providing inputs that simulate inputs from an HID. In some embodiments, the signal device 166 comprises a Single Board Computer (SBC). In other embodiments, the providing one or more signals (at 206) is performed by a provisioning system 150.

The process 200 shown in FIG. 2 further includes analyzing information recorded by the imaging system to determine a state of the device at 208. For example, in some embodiments, the imaging system provides a video feed, and the analyzing information (at 208) includes analyzing the video feed from the imaging system using a computer vision technique (e.g. optical character recognition (OCR), template matching, etc.).

In the embodiment shown in FIG. 2, the process 200 includes determining whether the device is operating correctly at 210. For example, in some embodiments, the determining whether the device is operating correctly (at 210) includes determining whether an expected state indicating successful operation is indicated by the information recorded by the imaging system. Alternately, the determining whether the device is operating correctly (at 210) may include determining whether an unexpected or error state exists based on the information recorded by the imaging system, indicating unsuccessful or incorrect operation of the device. More specifically, in some embodiments involving provisioning of the device 110, the determining (at 210) may include determining whether each stage or operation of the provisioning process has been successfully (or unsuccessfully) achieved. Similarly, in some embodiments involving testing of the device 110, the determining (at 210) may include determining whether each stage or operation of the testing process has been successfully (or unsuccessfully) achieved.

If it is determined that the device is not operating correctly (at 210), then the process 200 proceeds to determine whether corrective action is available at 218. For example, in some embodiments, the determining whether correction action is available (at 218) may include determining whether any of the one or more inputs may be adjusted to correct the state of the device. If it is determined that corrective action is available (at 218) then the process 200 includes adjusting one or more input signals to attempt to correct the device operating condition at 220. The process 200 then returns to providing one or more input signals to the device (at 206), and the above-noted operations 206-210, 218-220 may be repeated until it is determined that the device is operating correctly (at 210).

Alternately, if it is determined that the device is not operating correctly (at 210) and that there is no suitable corrective action available (at 218), then the process 200 proceeds to reporting the device operating condition at 214. For example, in some embodiments, reporting the device operating condition (at 214) may include reporting that an unsuccessful provisioning of a component on the device has occurred. In other embodiments, reporting the device operating condition (at 214) may include reporting that an unsuccessful testing of a component on the device has occurred.

Returning again to the determination at 210, if it is determined that the device is operating correctly (at 210), then the process 200 proceeds to determine whether a desired final operating state has been achieved at 212. For example, in embodiments involving provisioning of the device 110, the determining (at 212) may include determining whether the provisioning process has been successfully completed. Similarly, in embodiments involving testing of the device 110, the determining (at 212) may include determining whether the testing process has been successfully completed.

If it is determined that the desired final operating state has not been achieved (at 212), then the process 200 returns to providing one or more input signals to the device (at 206), and the above-noted operations 206-220 may be repeated until it is determined that the desired final operating state of the device has been achieved (at 212). The process 200 then proceeds to reporting the device operating condition at 214. For example, in some embodiments, reporting the device operating condition (at 214) may include reporting that a provisioning of one or more components on the device has been successfully completed. In other embodiments, reporting the device operating condition (at 214) may include reporting that a testing of one or more components on the device has been successfully completed. The process 200 then ends or continues to other operations at 216.

It will be appreciated that the process 200 shown in FIG. 2 is merely one particular implementation, and that various alternate implementations may be conceived in accordance with the present disclosure. For example, it will be appreciated that embodiments of systems and methods in accordance with the present disclosure may be employed in one or more of the following possible use scenarios: (1) automated device provisioning, (2) end to end UI testing on real devices, (3) automated script generation using CV, (4) ability to detect and resolve errors during setup, and/or alert users accordingly, (5) auto-accept unforeseen prompts during setup, and/or (6) intelligent automated sequences of actions by reading text on screen, parsing using NLP and clicking appropriate buttons based on prior training data.

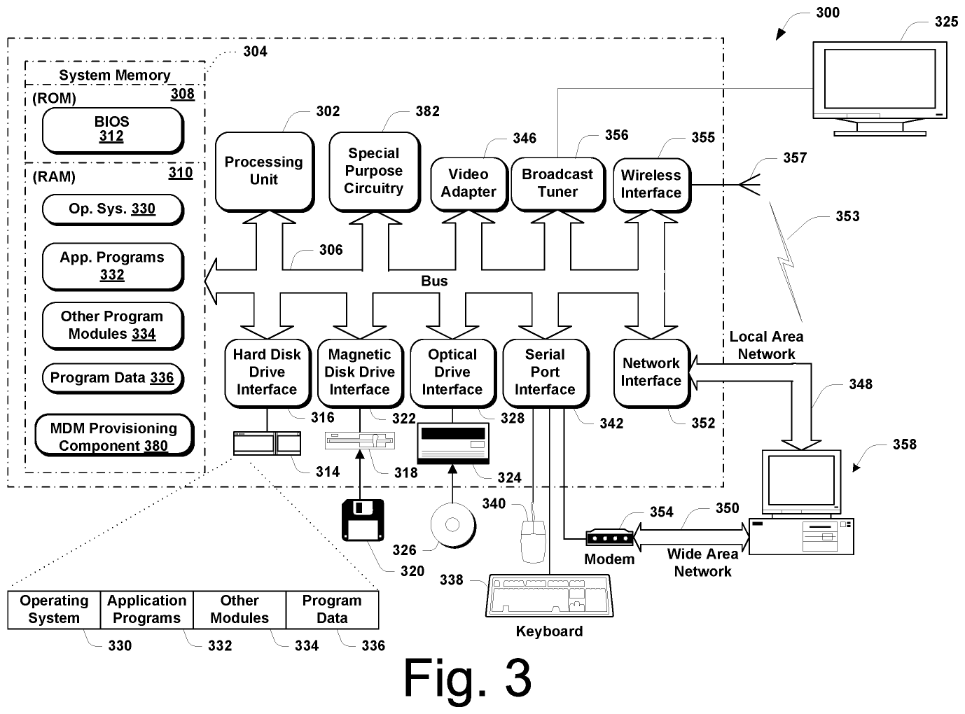

It will be appreciated that embodiments of systems and methods in accordance with the present disclosure may be implemented in a variety of systems, devices, and environments. For example, FIG. 3 is a schematic view of an exemplary system 300 in accordance with another possible embodiment. In some embodiments, the system 300 may include one or more processors (or processing units) 302, special purpose circuitry 382, a memory 304, and a bus 306 that couples various system components, including the memory 304, to the one or more processors 302 and special purpose circuitry 382 (e.g. ASIC, FPGA, etc.). The bus 306 represents one or more of any of several types of bus structures, including a memory bus or memory controller, a peripheral bus, an accelerated graphics port, and a processor or local bus using any of a variety of bus architectures. In this implementation, the memory 304 includes read only memory (ROM) 308 and random access memory (RAM) 310. A basic input/output system (BIOS) 312, containing the basic routines that help to transfer information between elements within the system 300, such as during start-up, is stored in ROM 308.

The exemplary system 300 further includes a hard disk drive 314 for reading from and writing to a hard disk (not shown), and is connected to the bus 306 via a hard disk driver interface 316 (e.g., a SCSI, ATA, or other type of interface). A magnetic disk drive 318 for reading from and writing to a removable magnetic disk 320, is connected to the system bus 306 via a magnetic disk drive interface 322. Similarly, an optical disk drive 324 for reading from or writing to a removable optical disk 326 such as a CD ROM, DVD, or other optical media, connected to the bus 306 via an optical drive interface 328. The drives and their associated computer-readable media provide nonvolatile storage of computer readable instructions, data structures, program modules and other data for the system 300. Although the exemplary system 300 described herein employs a hard disk, a removable magnetic disk 320 and a removable optical disk 326, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used.

As further shown in FIG. 3, a number of program modules may be stored on the memory 304 (e.g. the ROM 308 or the RAM 310) including an operating system 330, one or more application programs 332, other program modules 334, and program data 336 (e.g. the data store 320, image data, audio data, three dimensional object models, etc.). Alternately, these program modules may be stored on other computer-readable media, including the hard disk, the magnetic disk 320, or the optical disk 326. For purposes of illustration, programs and other executable program components, such as the operating system 330, are illustrated in FIG. 3 as discrete blocks, although it is recognized that such programs and components reside at various times in different storage components of the system 300, and may be executed by the processor(s) 302 or the special purpose circuitry 382 of the system 300.

A user may enter commands and information into the system 300 through input devices such as a keyboard 338 and a pointing device 340. Other input devices (not shown) may include a microphone, joystick, game pad, satellite dish, scanner, or the like. These and other input devices are connected to the processing unit 302 and special purpose circuitry 382 through an interface 342 that is coupled to the system bus 306. A monitor 325 may be connected to the bus 306 via an interface, such as a video adapter 346. In addition, the system 300 may also include other peripheral output devices (not shown) such as speakers, cameras, scanners, and printers.

The system 600 may operate in a networked environment using logical connections to one or more remote computers (or servers) 658. Such remote computers (or servers) 658 may be a personal computer, a server, a router, a network PC, a peer device or other common network node, and may include many or all of the elements described above relative to system 600. The logical connections depicted in FIG. 3 may include one or more of a local area network (LAN) 348 and a wide area network (WAN) 350. Such networking environments are commonplace in offices, enterprise-wide computer networks, intranets, and the Internet. In a networked environment, program modules depicted relative to the system 300, or portions thereof, may be stored in the memory 304, or in a remote memory storage device.

In this embodiment, the system 300 also includes one or more broadcast tuners 356. The broadcast tuner 356 may receive broadcast signals directly (e.g., analog or digital cable transmissions fed directly into the tuner 356) or via a reception device (e.g., via a sensor, an antenna, a satellite dish, etc.).

When used in a LAN networking environment, the system 300 may be connected to the local network 348 through a network interface (or adapter) 352. When used in a WAN networking environment, the system 300 typically includes a modem 354 or other means for establishing communications over the wide area network 350, such as the Internet. The modem 354, which may be internal or external, may be connected to the bus 306 via the serial port interface 342. Similarly, the system 300 may exchange (send or receive) wireless signals 353 with one or more remote devices, using a wireless interface 355 coupled to a wireless communicator 357.

As further shown in FIG. 3, an MDM component 380 may be stored in the memory 304 of the system 300. The MDM component 380 may be configured to perform operations as disclosed herein, including operations associated with provisioning and testing of MDM agents on devices, and may be implemented using software, hardware, firmware, or any suitable combination thereof. In cooperation with the other components of the system 300, such as the processing unit 302 or the special purpose circuitry 382, the MDM component 380 may be operable to perform one or more implementations of processes for provisioning and testing of MDM agents (or other software) as described herein in accordance with the present disclosure.

Accordingly, in some embodiments, a system includes at least one processor, and a memory operatively coupled to the at least one processor, the memory storing processor-readable instructions configured to perform operations including at least: monitoring a display of a device using an imaging system; providing one or more input signals to the device to simulate one or more human inputs; analyzing information recorded by the imaging system to determine a state of the device responsive to the one or more input signals; and determining whether the state of the device is indicative of a successful operating condition based at least partially on the information recorded by the imaging system. In some embodiments, the operations further comprise: if the state of the device is not indicative of the successful operating condition, adjusting one or more input signals to the device; and re-analyzing information recorded by the imaging system to determine a new state of the device responsive to the adjusted one or more input signals.

In some embodiments, the providing one or more input signals to the device to simulate one or more human inputs comprises providing one or more input signals to the device from a signal device to simulate one or more human via a human interface device (HID). And in some embodiments, the providing one or more input signals to the device to simulate one or more human inputs comprises providing one or more input signals to the device from a single board computer (SBC) to simulate one or more inputs via a USB HID.

In addition, in some embodiments, the analyzing information recorded by the imaging system to determine a state of the device responsive to the one or more input signals comprises analyzing information recorded by the imaging system using one or more computer vision techniques to determine a state of the device responsive to the one or more input signals. And in further embodiments, the determining whether the state of the device is indicative of a successful operating condition based at least partially on the information recorded by the imaging system comprises determining whether the state of the device is indicative of a successful software installation condition. In other embodiments, the determining whether the state of the device is indicative of a successful operating condition based at least partially on the information recorded by the imaging system comprises determining whether the state of the device is indicative of a successful software testing condition.

Similarly, in some embodiments, a method comprises: monitoring a display of a device using an imaging system; providing one or more input signals to the device to simulate one or more human inputs; analyzing information recorded by the imaging system to determine a state of the device responsive to the one or more input signals; and determining whether the state of the device is indicative of a successful operating condition based at least partially on the information recorded by the imaging system. In some embodiments, the method further includes: if the state of the device is not indicative of the successful operating condition, adjusting one or more input signals to the device; and re-analyzing information recorded by the imaging system to determine a new state of the device responsive to the adjusted one or more input signals.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system, comprising:
at least one processor;
a memory operatively coupled to the at least one processor, the memory storing processor-readable instructions configured to perform operations including at least:
monitoring a display of a device using an imaging system;
providing one or more input signals to the device to simulate one or more human inputs;
analyzing information recorded by the imaging system to determine a state of the device responsive to the one or more input signals; and
determining whether the state of the device is indicative of a successful operating condition based at least partially on the information recorded by the imaging system.

2. The system of claim 1, wherein the operations further comprise:
if the state of the device is not indicative of the successful operating condition, adjusting one or more input signals to the device; and
re-analyzing information recorded by the imaging system to determine a new state of the device responsive to the adjusted one or more input signals.

3. The system of claim 1, wherein providing one or more input signals to the device to simulate one or more human inputs comprises:
providing one or more input signals to the device from a signal device to simulate one or more human via a human interface device (HID).

4. The system of claim 1, wherein providing one or more input signals to the device to simulate one or more human inputs comprises:
providing one or more input signals to the device from a single board computer (SBC) to simulate one or more inputs via a USB HID.

5. The system of claim 1, wherein analyzing information recorded by the imaging system to determine a state of the device responsive to the one or more input signals comprises:
analyzing information recorded by the imaging system using one or more computer vision techniques to determine a state of the device responsive to the one or more input signals.

6. The system of claim 1, wherein determining whether the state of the device is indicative of a successful operating condition based at least partially on the information recorded by the imaging system comprises:
determining whether the state of the device is indicative of a successful software installation condition.

7. The system of claim 1, wherein determining whether the state of the device is indicative of a successful operating condition based at least partially on the information recorded by the imaging system comprises:
determining whether the state of the device is indicative of a successful software testing condition.

8. A method, comprising:
monitoring a display of a device using an imaging system;
providing one or more input signals to the device to simulate one or more human inputs;
analyzing information recorded by the imaging system to determine a state of the device responsive to the one or more input signals; and
determining whether the state of the device is indicative of a successful operating condition based at least partially on the information recorded by the imaging system.

9. The method of claim 8, further comprising:
if the state of the device is not indicative of the successful operating condition, adjusting one or more input signals to the device; and
re-analyzing information recorded by the imaging system to determine a new state of the device responsive to the adjusted one or more input signals.

10. The method of claim 8, wherein providing one or more input signals to the device to simulate one or more human inputs comprises:
providing one or more input signals to the device from a signal device to simulate one or more human via a human interface device (HID).

11. The method of claim 8, wherein providing one or more input signals to the device to simulate one or more human inputs comprises:
providing one or more input signals to the device from a single board computer (SBC) to simulate one or more inputs via a USB HID.

12. The method of claim 8, wherein analyzing information recorded by the imaging system to determine a state of the device responsive to the one or more input signals comprises:
analyzing information recorded by the imaging system using one or more computer vision techniques to determine a state of the device responsive to the one or more input signals.

13. The method of claim 8, wherein determining whether the state of the device is indicative of a successful operating condition based at least partially on the information recorded by the imaging system comprises:
determining whether the state of the device is indicative of a successful software installation condition.

14. The method of claim 8, wherein determining whether the state of the device is indicative of a successful operating condition based at least partially on the information recorded by the imaging system comprises:
determining whether the state of the device is indicative of a successful software testing condition.
